(19) United States
(12) Patent Application Publication
(10) Pub. No.: US 2011/0032192 A1
(43) Pub. Date: Feb. 10, 2011

(54) TOUCH SCREEN CONTROL SYSTEM AND METHOD

(75) Inventors: Julie Mills, Madison, WI (US); Robert Tham, Middleton, WI (US)

Correspondence Address: GE Healthcare, IP Department, 20225 Water Tower Blvd., Mail Code W492, BROOKFIELD, WI, 53045, US

(73) Assignee: GENERAL ELECTRIC COMPANY, Schenectady, NY (US)

(21) Appl. No.: 12/535,291

(22) Filed: Aug. 4, 2009

(51) Int. Cl. G06F 3/041

(52) U.S. Cl. 345/173

(57) ABSTRACT

A system is disclosed herein. The system includes an anesthesia machine, and a control system. The control system includes a touch screen, and a computer. The computer is configured to identify a first position at which the touch screen is contacted, identify a control parameter of the anesthesia machine based on the first position, and identify a second position at which the touch screen is contacted. The computer is further configured to identify a contact range comprising a generally continuous sequence of contact points including and extending in a direction away from the second position at which the touch screen is contacted. The computer is further configured to regulate the control parameter of the anesthesia machine based on the contact range.

### BACKGROUND OF THE INVENTION

The subject matter disclosed herein relates to a touch screen control system and method.

Anesthesia systems administer anesthesia for purposes such as blocking the conscious perception of pain, producing unconsciousness, preventing memory formation, and/or preventing unwanted movement. Anesthesia systems commonly implement touch screen input devices for controlling the manner in which anesthesia is administered.

Conventional touch screen devices comprise a display that can detect the location of points of contact within the display area. Touch screen devices are commonly menu driven such that a user establishes contact with specific regions of the display area in order to select a menu item. In this manner, the display can function as a device adapted to visually convey data as well as an input device.

One problem with touch screen devices is that they can complicate the process of regulating specific control parameters within their range of operation. As an example, consider a control parameter such as volume having a relatively wide operational range. The process of selecting a specific volume level can be less intuitive and more complicated with a touch screen than with a conventional analog dial. This problem becomes increasingly significant in the context of touch screen devices implemented to regulate anesthesia system operational parameters with a high degree of precision.

### BRIEF DESCRIPTION OF THE INVENTION

The above-mentioned shortcomings, disadvantages and problems are addressed herein which will be understood by reading and understanding the following specification.

In an embodiment, a method includes identifying a first position at which a touch screen is contacted, and identifying a control parameter of an anesthesia machine based on the first position. The method also includes identifying a second position at which the touch screen is contacted, and identifying a contact range comprising a generally continuous sequence of contact points including and extending in a direction away from the second position at which the touch screen is contacted. The method also includes regulating the control parameter of the anesthesia machine based on the contact range.

In another embodiment, a system includes an anesthesia machine, and a control system operatively connected to the anesthesia machine. The control system includes a touch screen, and a computer operatively connected to the touch screen. The computer is configured to identify a first position at which the touch screen is contacted, identify a control parameter of the anesthesia machine based on the first position, and identify a second position at which the touch screen is contacted. The computer is further configured to identify a contact range comprising a generally continuous sequence of contact points including and extending in a direction away from the second position at which the touch screen is contacted. The computer is further configured to regulate the control parameter of the anesthesia machine based on the contact range.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram illustrating a control system in accordance with an embodiment;

FIG. 2 is a schematic diagram illustrating an anesthesia system in accordance with an embodiment; and

FIG. 3 is a flow chart illustrating an algorithm in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

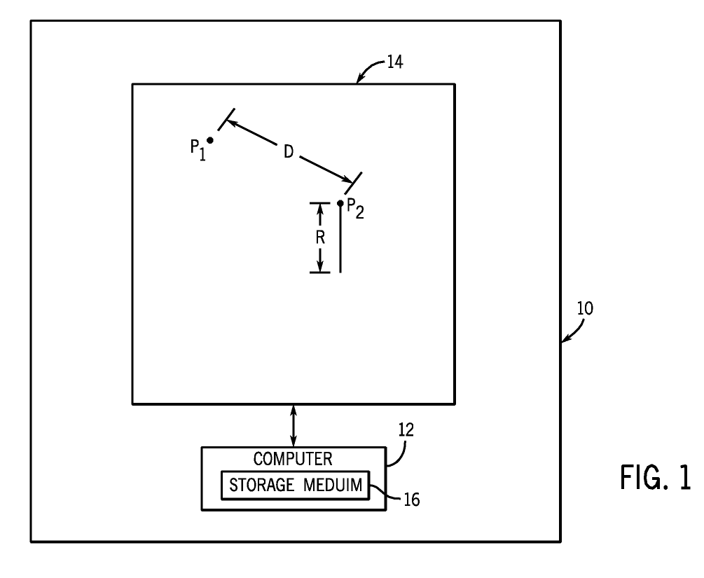

Referring to FIG. 1, a control system 10 is shown in accordance with an embodiment. The control system 10 includes a computer 12 operatively connected to a touch screen display 14. The computer 12 includes a computer-readable storage medium 16 such as a hard drive, RAM, CD, DVD, etc. The control system 10 will hereinafter be described in accordance with an embodiment wherein it is implemented as part of an anesthesia system 30; however it should be appreciated that the control system 10 may alternatively be implemented in a variety of other devices such as a ventilator system.

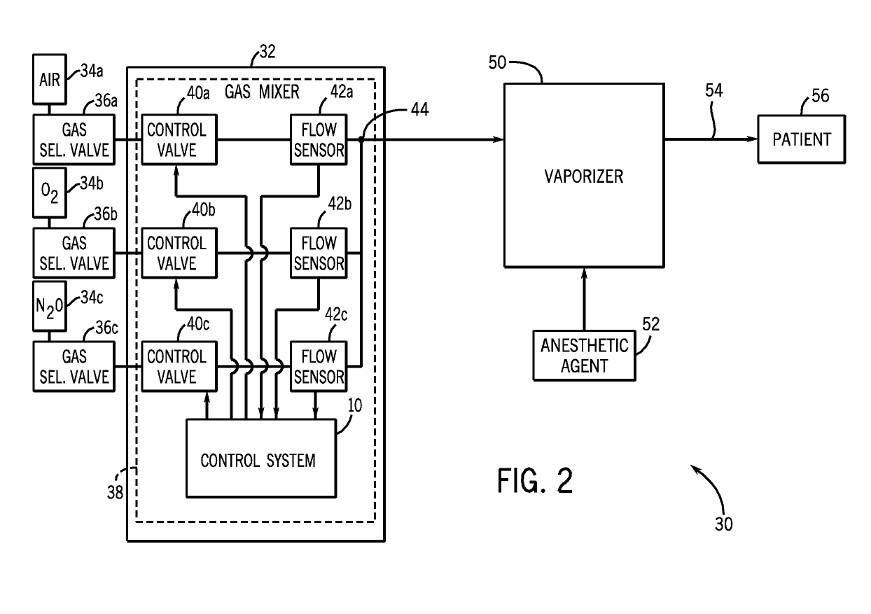

Referring to FIG. 2, the anesthesia system 30 is schematically depicted in accordance with one embodiment. The anesthesia system 30 includes an anesthesia machine 32, a plurality of gas storage devices 34a, 34b and 34c, and a vaporizer 50. In a typical hospital environment, the gas storage devices 34a, 34b and 34c each comprise a centrally located storage tank configured to supply medical gas to multiple hospital rooms via a wall outlet. The storage tanks are generally pressurized to facilitate the transfer of the medical gas to the anesthesia machine 32.

The gas storage devices 34a, 34b and 34c will hereinafter be described for illustrative purposes as comprising an air tank 34a, an oxygen (O2) tank 34b, and a nitrous oxide (N2O) tank 34c. The gas storage tanks 34a, 34b and 34c are each connected to one of the gas selector valves 36a, 36b, and 36c. The gas selector valves 36a, 36b. and 36c may be implemented to shut off the flow of medical gas from the storage tanks 34a, 34b and 34c when the anesthesia machine 32 is not operational. When one of the gas selector valves 36a, 36b, and 36c is opened, gas from a respective storage tank 34a, 34b and 34c is transferred under pressure to the anesthesia machine 32.

The anesthesia machine 32 includes a gas mixer 38 adapted to receive medical gas from the storage tanks 34a, 34b and 34c. The gas mixer 38 includes a plurality of control valves 40a, 40b and 40c that are respectively connected to one of the gas selector valves 36a, 36b, and 36c. The gas mixer 38 also includes a plurality of flow sensors 42a, 42b and 42c that are each disposed downstream from a respective control valve 40a, 40b, and 40c. After passing through one of the control valves 40a, 40b, and 40c, and passing by one of the flow sensors 42a, 42b and 42c, the air, O2 and N2O are combined to form a mixed gas at the mixed gas outlet 44.

The control valves 40a, 40b and 40c and the flow sensors 42a, 42b and 42c are each connected to the control system 10. The control system 10 is configured to operate the control valves 40a, 40b and 40c in response to user input and/or gas flow rate feedback from the sensors 42a, 42b and 42c. According to one embodiment, a user can specify air, O2 and N2O concentrations via the touch screen display 14 (shown in FIG. 1) of the control system 10, and thereafter the computer 12 (shown in FIG. 1) regulates the control valves 40a, 40b and 40c in a manner adapted to produce the user specified concentrations of air, O2 and N2O at the mixed gas outlet 44. The computer 12 may additionally be configured to adjust the control valves 40a, 40b and 40c in response to feedback from the sensors 42a, 42b and 42c if, for example, the measured concentrations of the air, O2 and N2O are inconsistent with the user specified concentrations.

The mixed gas from the mixed gas outlet 44 is transferred to the vaporizer 50. The vaporizer 50 is configured to vaporize an anesthetic agent 52, and to combine the vaporized anesthetic agent with the mixed gas from the mixed gas outlet 44. The vaporized anesthetic agent and mixed gas combination passes through a breathing tube 54 and is delivered to the patient 56.

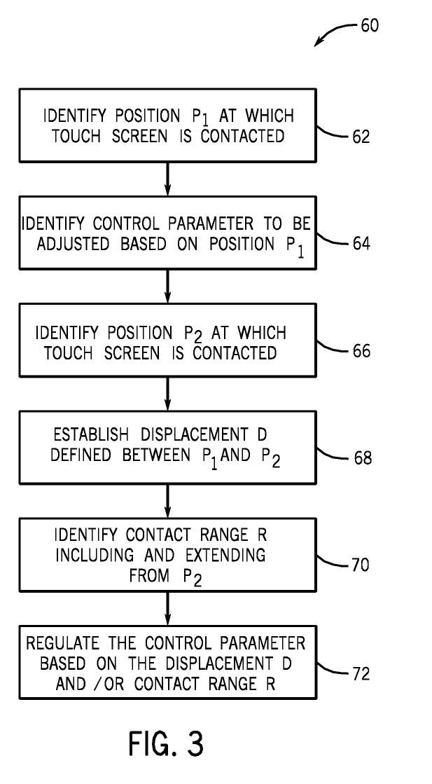

Referring to FIG. 3, a flow chart illustrating an algorithm 60 is shown in accordance with an embodiment. The technical effect of the algorithm 60 is to enable a user to operate the control system 10 in a simple and intuitive manner and thereby control a remotely located device such as the anesthesia machine 32 with a high degree of precision. According to one embodiment, the algorithm 60 comprises a computer program stored on the computer-readable storage medium 16 (shown in FIG. 1). The individual blocks 62-76 represent steps that can be performed by the computer 12 (shown in FIG. 1).

Referring to FIGS. 1 and 3, at step 62 the algorithm 60 is configured to identify a position P1 at which touch screen contact is initially established. At step 64, the algorithm 60 identifies a control parameter of remotely located device to be adjusted based on position P1. For purposes of this disclosure, the device to be adjusted is remotely located as defined relative to the control system 10. According to one embodiment, the device to be adjusted comprises the anesthesia machine 32 and the associated control parameters include an air concentration; an oxygen concentration; a nitrous oxide concentration; and/or an anesthetic agent concentration. According to another embodiment, the device to be adjusted comprises a ventilator (not shown) and the associated control parameters include the size of breath (settable via tidal volumes and inspiratory pressure level); minute volume; respiratory rates; inspired to expired ratio; and/or positive end-expiratory pressure (PEEP).

For purposes of illustrating steps 62-64, assume the touch screen display 14 comprises a user interface graphically identifying a plurality of adjustable parameters. At step 62 a user can establish position P1 by contacting or touching the specified region of the touch screen display 14 corresponding to the parameter to be adjusted. Thereafter, at step 64, the computer 12 can identify the control parameter to be adjusted based on the position P1 and its location relative to the user interface.

At step 66 the algorithm 60 is configured to identify a position P2 at which touch screen contact is subsequently established. It is envisioned that position P2 may be established while the user maintains touch screen contact at position P1, and that the positions P1 and P2 may be established with separate fingers/digits. As an example, a user may initially contact the touch screen display 14 at position P1 using their right-hand thumb. Thereafter, while maintaining touch screen/thumb contact at position P1, the user may contact the touch screen display 14 at position P2 using their right-hand index finger.

At step 68 the algorithm 60 is configured to establish a displacement between the position P1 and the position P2. For purposes of this disclosure, the term displacement should be defined to include linear displacement and/or angular displacement. At step 70 the algorithm 60 is configured to identify a contact range R comprising a generally continuous sequence of contact points including and extending in a direction away from the position P2. The solid line extending from the position P2 in FIG. 2 represents the contact range R in accordance with an illustrative embodiment. It is envisioned that the contact range R can be generated by establishing touch screen contact at position P2 (e.g., in accordance with step 66), and thereafter dragging a finger/digit across the surface of the touch screen 14 in a direction extending away from the position P2.

At step 72, the algorithm 60 is configured to regulate the previously identified control parameter based on the displacement D and/or the contact range R. According to one embodiment, at step 72 the magnitude of the control parameter is regulated based on the length of the contact range R and the direction of the control parameter is regulated based on the direction of the contact range R. As an example, the control parameter may remain constant or unchanged upon initial touch screen engagement at position P2. Thereafter, the control parameter can be regulated based on the length of the contact range R such that a short contact range R changes the control parameter by a small amount and a long contact range R changes the control parameter by a large amount. Additionally, the direction of the control parameter is regulated based on the direction of the contact range R such that, for example, a contact range extending upward or to the right will increase the control parameter while a contact range extending downward or to the left will decrease the control parameter.

According to another embodiment, at step 72 the control parameter is regulated by an amount based on the proportional length of the contact range R as measured relative to the displacement D. More precisely, the control parameter may be adjusted by the ratio R/D of its current or unadjusted magnitude. As an example, assume the displacement D is 100 millimeters, the length of the range R is 10 millimeters, and the current unadjusted magnitude of the control parameter is 6.0 milliliters/second. According to this example, the magnitude of the control parameter would be increased or decreased by the ratio of R/D or 1/10^{th} of the current control parameter magnitude. Since the current magnitude of the control parameter is 6.0 milliliters/second, the control parameter would be increased or decreased by the amount 1/10*(6.0)=0.6 militers/second.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method comprising:
identifying a first position at which a touch screen is contacted;
identifying a control parameter of an anesthesia machine to be adjusted based on the first position;
identifying a second position at which the touch screen is contacted;
identifying a contact range comprising a generally continuous sequence of contact points including and extending in a direction away from the second position at which the touch screen is contacted; and
regulating the control parameter of the anesthesia machine based on the contact range.

2. The method of claim 1, wherein said regulating the control parameter of the anesthesia machine comprises regulating the control parameter based on the magnitude and direction of the contact range.

3. The method of claim 1, further comprising establishing a displacement defined between the first position and the second position.

4. The method of claim 2, wherein said regulating the control parameter comprises regulating the control parameter based on the displacement and the contact range.

5. The method of claim 1, wherein said regulating a control parameter comprises regulating one of an air concentration, an oxygen concentration, a nitrous oxide concentration, and an anesthetic agent concentration.

6. A system comprising:
an anesthesia machine; and
a control system operatively connected to the anesthesia machine, the control system comprising:
a touch screen; and
a computer operatively connected to the touch screen, said computer configured to:
identify a first position at which the touch screen is contacted;
identify a control parameter of the anesthesia machine based on the first position;
identify a second position at which the touch screen is contacted;
identify a contact range comprising a generally continuous sequence of contact points including and extending in a direction away from the second position at which the touch screen is contacted; and
regulate the control parameter of the anesthesia machine based on the contact range.

7. The system of claim 6, wherein the control parameter comprises one of an air concentration, an oxygen concentration, a nitrous oxide concentration, and an anesthetic agent concentration.

8. The system of claim 6, wherein the computer is configured to regulate the control parameter of the anesthesia machine based on the magnitude and direction of the contact range.

9. The system of claim 6, wherein the computer is configured to establish a displacement defined between the first position and the second position.

10. The system of claim 9, wherein the computer is configured to regulate the control parameter of the anesthesia machine based on the displacement and the contact range.
